(19) United States
(12) Patent Application Publication
(10) Pub. No.: US 2023/0413335 A1
(43) Pub. Date: Dec. 21, 2023

(54) TRANSMIT POWER CONTROL FOR MULTIPLE PRACH TRANSMISSIONS

(71) Applicants: Gang Xiong, Beaverton, OR (US); Debdeep Chatterjee, San Jose, CA (US); Yingyang Li, Beijing (CN); Yi Wang, Beijing (CN); Prerana Rane, Newark, CA (US)

(72) Inventors: Gang Xiong, Beaverton, OR (US); Debdeep Chatterjee, San Jose, CA (US); Yingyang Li, Beijing (CN); Yi Wang, Beijing (CN); Prerana Rane, Newark, CA (US)

(21) Appl. No.: 18/241,729

(22) Filed: Sep. 1, 2023

Related U.S. Application Data
(60) Provisional application No. 63/411,270, filed on Sep. 29, 2022.
(60) Provisional application No. 63/491,935, filed on Mar. 23, 2023.

(51) Int. Cl. H04W 74/08; H04W 52/36

(52) U.S. Cl. CPC H04W 74/0833; H04W 52/36

(57) ABSTRACT

An apparatus and system are described for power control transmission for multiple physical random access channel (PRACH) transmissions. The systems include repetition level ramping for the PRACH transmissions, as well as power control mechanisms for PRACH transmissions that use identical transmission (Tx) beams and that use different Tx beams. The number of repetition attempts for a PRACH transmission increases when a random access response (RAR) is not received or does not pass contention resolution for a maximum number of attempts. A PRACH transmission within one or more transmission occasions is cancelled if the power exceeds a maximum power for PRACH transmissions.

### PRIORITY CLAIM

This application claims the benefit of priority to U.S. Provisional Patent Application Ser. No. 63/411,270, filed Sep. 29, 2022, and U.S. Provisional Patent Application Ser. No. 63/491,935, filed Mar. 23, 2023, each of which is incorporated herein by reference in its entirety.

### BACKGROUND

Mobile communication has evolved significantly from early voice systems to highly sophisticated integrated communication platform. Next-generation (NG) wireless communication systems, including 5^{th} generation (5G) and sixth generation (6G) or new radio (NR) systems, are to provide access to information and sharing of data by various users (e.g., user equipment (UEs)) and applications. NR is to be a unified network/system that is to meet vastly different and sometimes conflicting performance dimensions and services driven by different services and applications. As such the complexity of such communication systems has increased. As expected, a number of issues abound with the advent of any new technology, including complexities related to various types of transmissions.

### BRIEF DESCRIPTION OF THE FIGURES

In the figures, which are not necessarily drawn to scale, like numerals may describe similar components in different views. Like numerals having different letter suffixes may represent different instances of similar components. The figures illustrate generally, by way of example, but not by way of limitation, various embodiments discussed in the present document.

FIG. 1A illustrates an architecture of a network, in accordance with some aspects.

FIG. 1B illustrates a non-roaming 5G system architecture in accordance with some aspects.

FIG. 1C illustrates a non-roaming 5G system architecture in accordance with some aspects.

FIG. 2 illustrates a block diagram of a communication device in accordance with some embodiments.

FIG. 3 illustrates a four step random access channel (RACH) procedure in accordance with some embodiments.

FIG. 4 illustrates association between a physical RACH (PRACH) repetition level and message 3 (Msg3) repetition level in accordance with some embodiments.

FIG. 5 illustrates transmit power for multiple PRACH transmissions with the same transmission (Tx) beam in accordance with some embodiments.

FIG. 6 illustrates path loss determination for multiple PRACH transmission with different Tx beams in accordance with some embodiments.

FIG. 7 illustrates a process of PRACH transmission in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

FIG. TA illustrates an architecture of a network in accordance with some aspects. The network 140A includes 3GPP LTE/4G and NG network functions that may be extended to 6G functions. Accordingly, although 5G will be referred to, it is to be understood that this is to extend as able to 6G structures, systems, and functions. A network function may be implemented as a discrete network element on a dedicated hardware, as a software instance running on dedicated hardware, and/or as a virtualized function instantiated on an appropriate platform, e.g., dedicated hardware or a cloud infrastructure.

The network 140A is shown to include user equipment (UE) 101 and UE 102. The UEs 101 and 102 are illustrated as smartphones (e.g., handheld touchscreen mobile computing devices connectable to one or more cellular networks) but may also include any mobile or non-mobile computing device, such as portable (laptop) or desktop computers, wireless handsets, drones, or any other computing device including a wired and/or wireless communications interface. The UEs 101 and 102 may be collectively referred to herein as UE 101, and UE 101 may be used to perform one or more of the techniques disclosed herein.

Any of the radio links described herein (e.g., as used in the network 140A or any other illustrated network) may operate according to any exemplary radio communication technology and/or standard. Any spectrum management scheme including, for example, dedicated licensed spectrum, unlicensed spectrum, (licensed) shared spectrum (such as Licensed Shared Access (LSA) in 2.3-2.4 GHz, 3.4-3.6 GHz, 3.6-3.8 GHz, and other frequencies and Spectrum Access System (SAS) in 3.55-3.7 GHz and other frequencies). Different Single Carrier or Orthogonal Frequency Domain Multiplexing (OFDM) modes (CP-OFDM, SC-FDMA, SC-OFDM, filter bank-based multicarrier (FBMC), OFDMA, etc.), and in particular 3GPP NR, may be used by allocating the OFDM carrier data bit vectors to the corresponding symbol resources.

In some aspects, any of the UEs 101 and 102 can comprise an Internet-of-Things (IoT) UE or a Cellular IoT (CIoT) UE, which can comprise a network access layer designed for low-power IoT applications utilizing short-lived UE connections. In some aspects, any of the UEs 101 and 102 can include a narrowband (NB) IoT UE (e.g., such as an enhanced NB-IoT (eNB-IoT) UE and Further Enhanced (FeNB-IoT) UE). An IoT UE can utilize technologies such as machine-to-machine (M2M) or machine-type communications (MTC) for exchanging data with an MTC server or device via a public land mobile network (PLMN), Proximity-Based Service (ProSe) or device-to-device (D2D) communication, sensor networks, or IoT networks. The M2M or MTC exchange of data may be a machine-initiated exchange of data. An IoT network includes interconnecting IoT UEs, which may include uniquely identifiable embedded computing devices (within the Internet infrastructure), with short-lived connections. The IoT UEs may execute background applications (e.g., keep-alive messages, status updates, etc.) to facilitate the connections of the IoT network. In some aspects, any of the UEs 101 and 102 can include enhanced MTC (eMTC) UEs or further enhanced MTC (FeMTC) UEs.

The UEs 101 and 102 may be configured to connect, e.g., communicatively couple, with a radio access network (RAN) 110. The RAN 110 may be, for example, an Evolved Universal Mobile Telecommunications System (UMTS) Terrestrial Radio Access Network (E-UTRAN), a NextGen RAN (NG RAN), or some other type of RAN.

The UEs 101 and 102 utilize connections 103 and 104, respectively, each of which comprises a physical communications interface or layer (discussed in further detail below); in this example, the connections 103 and 104 are illustrated as an air interface to enable communicative coupling, and may be consistent with cellular communications protocols, such as a Global System for Mobile Communications (GSM) protocol, a code-division multiple access (CDMA) network protocol, a Push-to-Talk (PTT) protocol, a PTT over Cellular (POC) protocol, a Universal Mobile Telecommunications System (UMTS) protocol, a 3GPP Long Term Evolution (LTE) protocol, a 5G protocol, a 6G protocol, and the like.

In an aspect, the UEs 101 and 102 may further directly exchange communication data via a ProSe interface 105. The ProSe interface 105 may alternatively be referred to as a sidelink (SL) interface comprising one or more logical channels, including but not limited to a Physical Sidelink Control Channel (PSCCH), a Physical Sidelink Shared Channel (PSSCH), a Physical Sidelink Discovery Channel (PSDCH), a Physical Sidelink Broadcast Channel (PSBCH), and a Physical Sidelink Feedback Channel (PSFCH).

The UE 102 is shown to be configured to access an access point (AP) 106 via connection 107. The connection 107 can comprise a local wireless connection, such as, for example, a connection consistent with any IEEE 802.11 protocol, according to which the AP 106 can comprise a wireless fidelity (WiFi®) router. In this example, the AP 106 is shown to be connected to the Internet without connecting to the core network of the wireless system (described in further detail below).

The RAN 110 can include one or more access nodes that enable the connections 103 and 104. These access nodes (ANs) may be referred to as base stations (BSs), NodeBs, evolved NodeBs (eNBs), Next Generation NodeBs (gNBs), RAN nodes, and the like, and can comprise ground stations (e.g., terrestrial access points) or satellite stations providing coverage within a geographic area (e.g., a cell). In some aspects, the communication nodes 111 and 112 may be transmission/reception points (TRPs). In instances when the communication nodes 111 and 112 are NodeBs (e.g., eNBs or gNBs), one or more TRPs can function within the communication cell of the NodeBs. The RAN 110 may include one or more RAN nodes for providing macrocells, e.g., macro RAN node 111, and one or more RAN nodes for providing femtocells or picocells (e.g., cells having smaller coverage areas, smaller user capacity, or higher bandwidth compared to macrocells), e.g., low power (LP) RAN node 112.

Any of the RAN nodes 111 and 112 can terminate the air interface protocol and may be the first point of contact for the UEs 101 and 102. In some aspects, any of the RAN nodes 111 and 112 can fulfill various logical functions for the RAN 110 including, but not limited to, radio network controller (RNC) functions such as radio bearer management, uplink and downlink dynamic radio resource management and data packet scheduling, and mobility management. In an example, any of the nodes 111 and/or 112 may be a gNB, an eNB, or another type of RAN node.

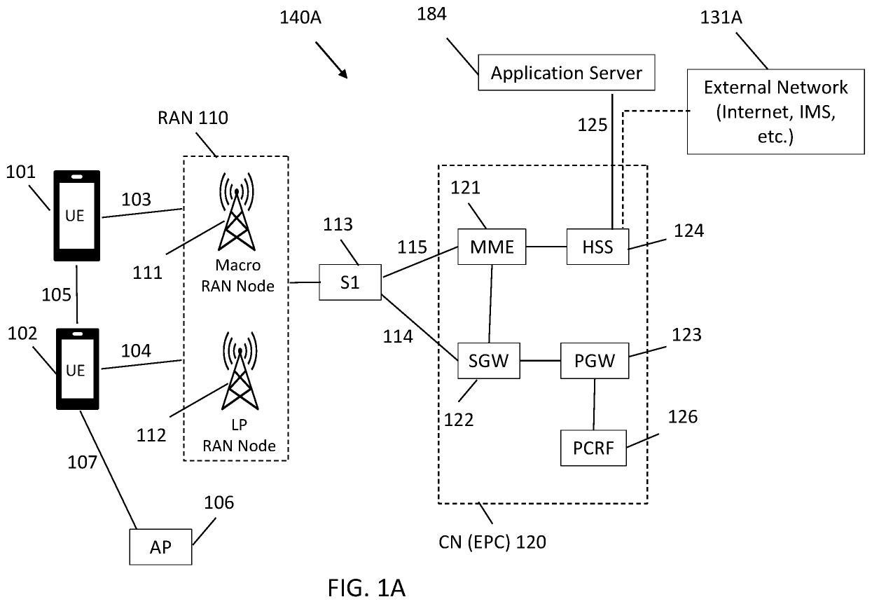

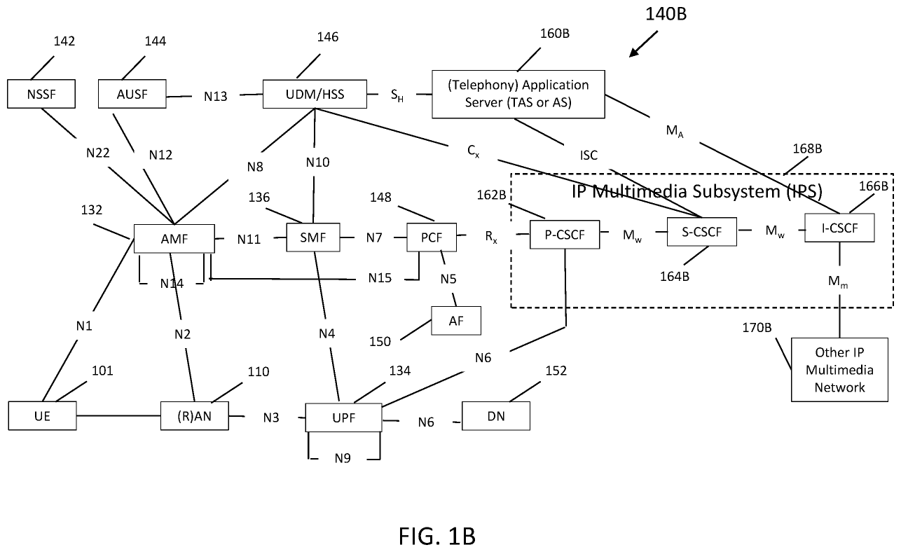

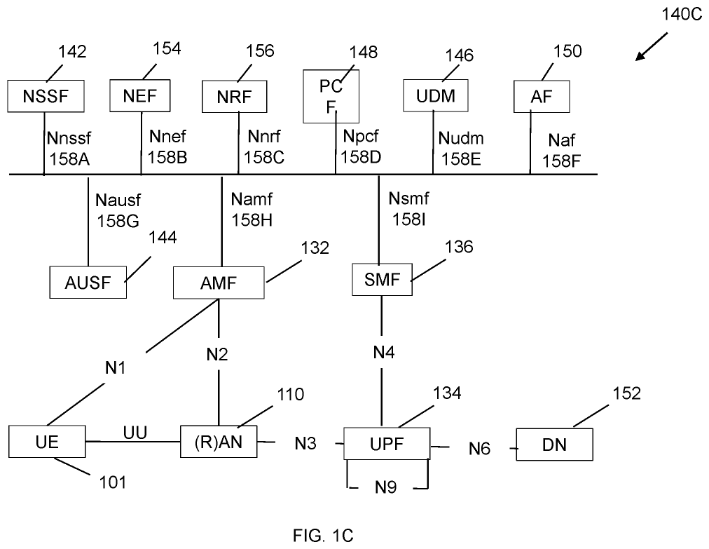

The RAN 110 is shown to be communicatively coupled to a core network (CN) 120 via an S1 interface 113. In aspects, the CN 120 may be an evolved packet core (EPC) network, a NextGen Packet Core (NPC) network, or some other type of CN (e.g., as illustrated in reference to FIGS. 1B-1C). In this aspect, the S1 interface 113 is split into two parts: the S1-U interface 114, which carries traffic data between the RAN nodes 111 and 112 and the serving gateway (S-GW) 122, and the S1-mobility management entity (MME) interface 115, which is a signaling interface between the RAN nodes 111 and 112 and MMEs 121.

In this aspect, the CN 120 comprises the MMEs 121, the S-GW 122, the Packet Data Network (PDN) Gateway (P-GW) 123, and a home subscriber server (HSS) 124. The MMEs 121 may be similar in function to the control plane of legacy Serving General Packet Radio Service (GPRS) Support Nodes (SGSN). The MMEs 121 may manage mobility aspects in access such as gateway selection and tracking area list management. The HSS 124 may comprise a database for network users, including subscription-related information to support the network entities' handling of communication sessions. The CN 120 may comprise one or several HSSs 124, depending on the number of mobile subscribers, on the capacity of the equipment, on the organization of the network, etc. For example, the HSS 124 can provide support for routing/roaming, authentication, authorization, naming/addressing resolution, location dependencies, etc.

The S-GW 122 may terminate the S1 interface 113 towards the RAN 110, and routes data packets between the RAN 110 and the CN 120. In addition, the S-GW 122 may be a local mobility anchor point for inter-RAN node handovers and also may provide an anchor for inter-3GPP mobility. Other responsibilities of the S-GW 122 may include a lawful intercept, charging, and some policy enforcement.

The P-GW 123 may terminate an SGi interface toward a PDN. The P-GW 123 may route data packets between the CN 120 and external networks such as a network including the application server 184 (alternatively referred to as application function (AF)) via an Internet Protocol (IP) interface 125. The P-GW 123 can also communicate data to other external networks 131A, which can include the Internet, IP multimedia subsystem (IPS) network, and other networks. Generally, the application server 184 may be an element offering applications that use IP bearer resources with the core network (e.g., UMTS Packet Services (PS) domain, LTE PS data services, etc.). In this aspect, the P-GW 123 is shown to be communicatively coupled to an application server 184 via an IP interface 125. The application server 184 can also be configured to support one or more communication services (e.g., Voice-over-Internet Protocol (VoIP) sessions, PTT sessions, group communication sessions, social networking services, etc.) for the UEs 101 and 102 via the CN 120.

The P-GW 123 may further be a node for policy enforcement and charging data collection. Policy and Charging Rules Function (PCRF) 126 is the policy and charging control element of the CN 120. In a non-roaming scenario, in some aspects, there may be a single PCRF in the Home Public Land Mobile Network (HPLMN) associated with a UE's Internet Protocol Connectivity Access Network (IP-CAN) session. In a roaming scenario with a local breakout of traffic, there may be two PCRFs associated with a UE's IP-CAN session: a Home PCRF (H-PCRF) within an HPLMN and a Visited PCRF (V-PCRF) within a Visited Public Land Mobile Network (VPLMN). The PCRF 126 may be communicatively coupled to the application server 184 via the P-GW 123.

In some aspects, the communication network 140A may be an IoT network or a 5G or 6G network, including 5G new radio network using communications in the licensed (5G NR) and the unlicensed (5G NR-U) spectrum. One of the current enablers of IoT is the narrowband-IoT (NB-IoT). Operation in the unlicensed spectrum may include dual connectivity (DC) operation and the standalone LTE system in the unlicensed spectrum, according to which LTE-based technology solely operates in unlicensed spectrum without the use of an “anchor” in the licensed spectrum, called MulteFire. Further enhanced operation of LTE systems in the licensed as well as unlicensed spectrum is expected in future releases and 5G systems. Such enhanced operations can include techniques for sidelink resource allocation and UE processing behaviors for NR sidelink V2X communications.

An NG system architecture (or 6G system architecture) can include the RAN 110 and a 5G core network (5GC) 120. The NG-RAN 110 can include a plurality of nodes, such as gNBs and NG-eNBs. The CN 120 (e.g., a 5G core network/5GC) can include an access and mobility function (AMF) and/or a user plane function (UPF). The AMF and the UPF may be communicatively coupled to the gNBs and the NG-eNBs via NG interfaces. More specifically, in some aspects, the gNBs and the NG-eNBs may be connected to the AMF by NG-C interfaces, and to the UPF by NG-U interfaces. The gNBs and the NG-eNBs may be coupled to each other via Xn interfaces.

In some aspects, the NG system architecture can use reference points between various nodes. In some aspects, each of the gNBs and the NG-eNBs may be implemented as a base station, a mobile edge server, a small cell, a home eNB, and so forth. In some aspects, a gNB may be a primary node (MN) and NG-eNB may be a secondary node (SN) in a 5G architecture.

FIG. 1B illustrates a non-roaming 5G system architecture in accordance with some aspects. In particular, FIG. 1B illustrates a 5G system architecture 140B in a reference point representation, which may be extended to a 6G system architecture. More specifically, UE 102 may be in communication with RAN 110 as well as one or more other 5GC network entities. The 5G system architecture 140B includes a plurality of network functions (NFs), such as an AMF 132, session management function (SMF) 136, policy control function (PCF) 148, application function (AF) 150, UPF 134, network slice selection function (NSSF) 142, authentication server function (AUSF) 144, and unified data management (UDM)/home subscriber server (HSS) 146.

The UPF 134 can provide a connection to a data network (DN) 152, which can include, for example, operator services, Internet access, or third-party services. The AMF 132 may be used to manage access control and mobility and can also include network slice selection functionality. The AMF 132 may provide UE-based authentication, authorization, mobility management, etc., and may be independent of the access technologies. The SMF 136 may be configured to set up and manage various sessions according to network policy. The SMF 136 may thus be responsible for session management and allocation of IP addresses to UEs. The SMF 136 may also select and control the UPF 134 for data transfer. The SMF 136 may be associated with a single session of a UE 101 or multiple sessions of the UE 101. This is to say that the UE 101 may have multiple 5G sessions. Different SMFs may be allocated to each session. The use of different SMFs may permit each session to be individually managed. As a consequence, the functionalities of each session may be independent of each other.

The UPF 134 may be deployed in one or more configurations according to the desired service type and may be connected with a data network. The PCF 148 may be configured to provide a policy framework using network slicing, mobility management, and roaming (similar to PCRF in a 4G communication system). The UDM may be configured to store subscriber profiles and data (similar to an HSS in a 4G communication system).

The AF 150 may provide information on the packet flow to the PCF 148 responsible for policy control to support a desired QoS. The PCF 148 may set mobility and session management policies for the UE 101. To this end, the PCF 148 may use the packet flow information to determine the appropriate policies for proper operation of the AMF 132 and SMF 136. The AUSF 144 may store data for UE authentication.

In some aspects, the 5G system architecture 140B includes an IP multimedia subsystem (IMS) 168B as well as a plurality of IP multimedia core network subsystem entities, such as call session control functions (CSCFs). More specifically, the IMS 168B includes a CSCF, which can act as a proxy CSCF (P-CSCF) 162B, a serving CSCF (S-CSCF) 164B, an emergency CSCF (E-CSCF) (not illustrated in FIG. 1B), or interrogating CSCF (I-CSCF) 166B. The P-CSCF 162B may be configured to be the first contact point for the UE 102 within the IM subsystem (IMS) 168B. The S-CSCF 164B may be configured to handle the session states in the network, and the E-CSCF may be configured to handle certain aspects of emergency sessions such as routing an emergency request to the correct emergency center or PSAP. The I-CSCF 166B may be configured to function as the contact point within an operator's network for all IMS connections destined to a subscriber of that network operator, or a roaming subscriber currently located within that network operator's service area. In some aspects, the I-CSCF 166B may be connected to another IP multimedia network 170B, e.g., an IMS operated by a different network operator.

In some aspects, the UDM/HSS 146 may be coupled to an application server 184, which can include a telephony application server (TAS) or another application server (AS) 160B. The AS 160B may be coupled to the IMS 168B via the S-CSCF 164B or the I-CSCF 166B.

A reference point representation shows that interaction can exist between corresponding NF services. For example, FIG. 1B illustrates the following reference points: N1 (between the UE 102 and the AMF 132), N2 (between the RAN 110 and the AMF 132), N3 (between the RAN 110 and the UPF 134), N4 (between the SMF 136 and the UPF 134), N5 (between the PCF 148 and the AF 150, not shown), N6 (between the UPF 134 and the DN 152), N7 (between the SMF 136 and the PCF 148, not shown), N8 (between the UDM 146 and the AMF 132, not shown), N9 (between two UPFs 134, not shown), N10 (between the UDM 146 and the SMF 136, not shown), N11 (between the AMF 132 and the SMF 136, not shown), N12 (between the AUSF 144 and the AMF 132, not shown), N13 (between the AUSF 144 and the UDM 146, not shown), N14 (between two AMFs 132, not shown), N15 (between the PCF 148 and the AMF 132 in case of a non-roaming scenario, or between the PCF 148 and a visited network and AMF 132 in case of a roaming scenario, not shown), N16 (between two SMFs, not shown), and N22 (between AMF 132 and NSSF 142, not shown). Other reference point representations not shown in FIG. 1B can also be used.

FIG. 1C illustrates a 5G system architecture 140C and a service-based representation. In addition to the network entities illustrated in FIG. 1B, system architecture 140C can also include a network exposure function (NEF) 154 and a network repository function (NRF) 156. In some aspects, 5G system architectures may be service-based and interaction between network functions may be represented by corresponding point-to-point reference points Ni or as service-based interfaces.

In some aspects, as illustrated in FIG. 1C, service-based representations may be used to represent network functions within the control plane that enable other authorized network functions to access their services. In this regard, 5G system architecture 140C can include the following service-based interfaces: Namf 158H (a service-based interface exhibited by the AMF 132), Nsmf 1581 (a service-based interface exhibited by the SMF 136), Nnef 158B (a service-based interface exhibited by the NEF 154), Npcf 158D (a service-based interface exhibited by the PCF 148), a Nudm 158E (a service-based interface exhibited by the UDM 146), Naf 158F (a service-based interface exhibited by the AF 150), Nnrf 158C (a service-based interface exhibited by the NRF 156), Nnssf 158A (a service-based interface exhibited by the NSSF 142), Nausf 158G (a service-based interface exhibited by the AUSF 144). Other service-based interfaces (e.g., Nudr, N5g-eir, and Nudsf) not shown in FIG. 1C can also be used.

NR-V2X architectures may support high-reliability low latency sidelink communications with a variety of traffic patterns, including periodic and aperiodic communications with random packet arrival time and size. Techniques disclosed herein may be used for supporting high reliability in distributed communication systems with dynamic topologies, including sidelink NR V2X communication systems.

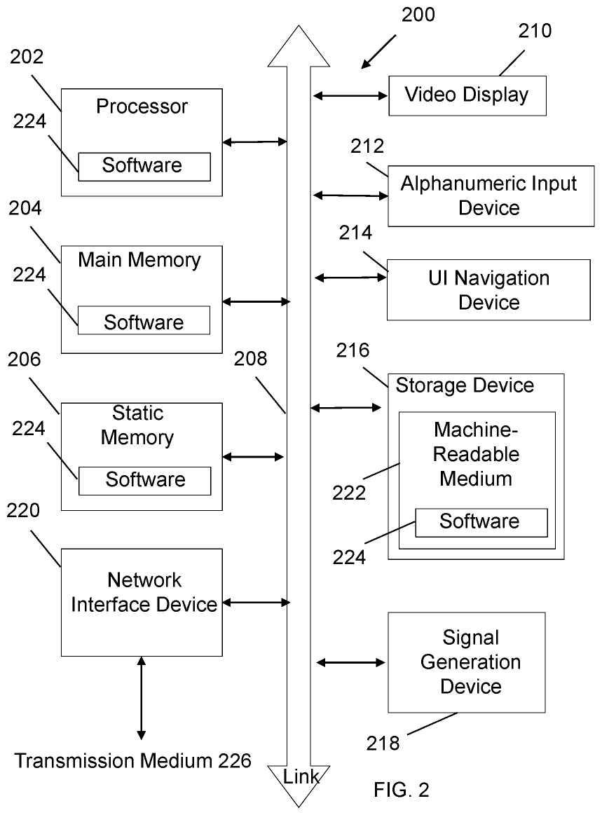

FIG. 2 illustrates a block diagram of a communication device in accordance with some embodiments. The communication device 200 may be a UE such as a specialized computer, a personal or laptop computer (PC), a tablet PC, or a smart phone, dedicated network equipment such as an eNB, a server running software to configure the server to operate as a network device, a virtual device, or any machine capable of executing instructions (sequential or otherwise) that specify actions to be taken by that machine. For example, the communication device 200 may be implemented as one or more of the devices shown in FIGS. 1A-IC. Note that communications described herein may be encoded before transmission by the transmitting entity (e.g., UE, gNB) for reception by the receiving entity (e.g., gNB, UE) and decoded after reception by the receiving entity.

Examples, as described herein, may include, or may operate on, logic or a number of components, modules, or mechanisms. Modules and components are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” (and “component”) is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

The communication device 200 may include a hardware processor (or equivalently processing circuitry) 202 (e.g., a central processing unit (CPU), a GPU, a hardware processor core, or any combination thereof), a main memory 204 and a static memory 206, some or all of which may communicate with each other via an interlink (e.g., bus) 208. The main memory 204 may contain any or all of removable storage and non-removable storage, volatile memory or non-volatile memory. The communication device 200 may further include a display unit 210 such as a video display, an alphanumeric input device 212 (e.g., a keyboard), and a user interface (UI) navigation device 214 (e.g., a mouse). In an example, the display unit 210, input device 212 and UI navigation device 214 may be a touch screen display. The communication device 200 may additionally include a storage device (e.g., drive unit) 216, a signal generation device 218 (e.g., a speaker), a network interface device 220, and one or more sensors, such as a global positioning system (GPS) sensor, compass, accelerometer, or another sensor. The communication device 200 may further include an output controller, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 216 may include a non-transitory machine readable medium 222 (hereinafter simply referred to as machine readable medium) on which is stored one or more sets of data structures or instructions 224 (e.g., software) embodying or utilized by any one or more of the techniques or functions described herein. The instructions 224 may also reside, completely or at least partially, within the main memory 204, within static memory 206, and/or within the hardware processor 202 during execution thereof by the communication device 200. While the machine readable medium 222 is illustrated as a single medium, the term “machine readable medium” may include a single medium or multiple media (e.g., a centralized or distributed database, and/or associated caches and servers) configured to store the one or more instructions 224.

The term “machine readable medium” may include any medium that is capable of storing, encoding, or carrying instructions for execution by the communication device 200 and that cause the communication device 200 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); and CD-ROM and DVD-ROM disks.

The instructions 224 may further be transmitted or received over a communications network using a transmission medium 226 via the network interface device 220 utilizing any one of a number of wireless local area network (WLAN) transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks. Communications over the networks may include one or more different protocols, such as Institute of Electrical and Electronics Engineers (IEEE) 802.11 family of standards known as Wi-Fi, IEEE 802.16 family of standards known as WiMax, IEEE 802.15.4 family of standards, a Long Term Evolution (LTE) family of standards, a Universal Mobile Telecommunications System (UMTS) family of standards, peer-to-peer (P2P) networks, a next generation (NG)/5th generation (5G) standards among others. In an example, the network interface device 220 may include one or more physical jacks (e.g., Ethernet, coaxial, or phone jacks) or one or more antennas to connect to the transmission medium 226.

Note that the term “circuitry” as used herein refers to, is part of, or includes hardware components such as an electronic circuit, a logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), etc., that are configured to provide the described functionality. In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” or “processor” as used herein thus refers to, is part of, or includes circuitry capable of sequentially and automatically carrying out a sequence of arithmetic or logical operations, or recording, storing, and/or transferring digital data. The term “processor circuitry” or “processor” may refer to one or more application processors, one or more baseband processors, a physical central processing unit (CPU), a single- or multi-core processor, and/or any other device capable of executing or otherwise operating computer-executable instructions, such as program code, software modules, and/or functional processes.

Any of the radio links described herein may operate according to any one or more of the following radio communication technologies and/or standards including but not limited to: a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology, for example Universal Mobile Telecommunications System (UMTS), Freedom of Multimedia Access (FOMA), 3GPP Long Term Evolution (LTE), 3GPP Long Term Evolution Advanced (LTE Advanced), Code division multiple access 2000 (CDMA2000), Cellular Digital Packet Data (CDPD), Mobitex, Third Generation (3G), Circuit Switched Data (CSD), High-Speed Circuit-Switched Data (HSCSD), Universal Mobile Telecommunications System (Third Generation) (UMTS (3G)), Wideband Code Division Multiple Access (Universal Mobile Telecommunications System) (W-CDMA (UMTS)), High Speed Packet Access (HSPA), High-Speed Downlink Packet Access (HSDPA), High-Speed Uplink Packet Access (HSUPA), High Speed Packet Access Plus (HSPA+), Universal Mobile Telecommunications System-Time-Division Duplex (UMTS-TDD), Time Division-Code Division Multiple Access (TD-CDMA), Time Division-Synchronous Code Division Multiple Access (TD-CDMA), 3rd Generation Partnership Project Release 8 (Pre-4th Generation) (3GPP Rel. 8 (Pre-4G)), 3GPP Rel. 9 (3rd Generation Partnership Project Release 9), 3GPP Rel. 10 (3rd Generation Partnership Project Release 10), 3GPP Rel. 11 (3rd Generation Partnership Project Release 11), 3GPP Rel. 12 (3rd Generation Partnership Project Release 12), 3GPP Rel. 13 (3rd Generation Partnership Project Release 13), 3GPP Rel. 14 (3rd Generation Partnership Project Release 14), 3GPP Rel. 15 (3rd Generation Partnership Project Release 15), 3GPP Rel. 16 (3rd Generation Partnership Project Release 16), 3GPP Rel. 17 (3rd Generation Partnership Project Release 17) and subsequent Releases (such as Rel. 18, Rel. 19, etc.), 3GPP 5G, 5G, 5G New Radio (5G NR), 3GPP 5G New Radio, 3GPP LTE Extra, LTE-Advanced Pro, LTE Licensed-Assisted Access (LAA), MuLTEfire, UMTS Terrestrial Radio Access (UTRA), Evolved UMTS Terrestrial Radio Access (E-UTRA), Long Term Evolution Advanced (4th Generation) (LTE Advanced (4G)), cdmaOne (2G), Code division multiple access 2000 (Third generation) (CDMA2000 (3G)), Evolution-Data Optimized or Evolution-Data Only (EV-DO), Advanced Mobile Phone System (1st Generation) (AMPS (1G)), Total Access Communication System/Extended Total Access Communication System (TACS/ETACS), Digital AMPS (2nd Generation) (D-AMPS (2G)), Push-to-talk (PTT), Mobile Telephone System (MTS), Improved Mobile Telephone System (IMTS), Advanced Mobile Telephone System (AMTS), OLT (Norwegian for Offentlig Landmobil Telefoni, Public Land Mobile Telephony), MTD (Swedish abbreviation for Mobiltelefonisystem D, or Mobile telephony system D), Public Automated Land Mobile (Autotel/PALM), ARP (Finnish for Autoradiopuhelin, “car radio phone”), NMT (Nordic Mobile Telephony), High capacity version of NTT (Nippon Telegraph and Telephone) (Hicap), Cellular Digital Packet Data (CDPD), Mobitex, DataTAC, Integrated Digital Enhanced Network (iDEN), Personal Digital Cellular (PDC), Circuit Switched Data (CSD), Personal Handy-phone System (PHS), Wideband Integrated Digital Enhanced Network (WiDEN), iBurst, Unlicensed Mobile Access (UMA), also referred to as 3GPP Generic Access Network, or GAN standard), Zigbee, Bluetooth®, Wireless Gigabit Alliance (WiGig) standard, mmWave standards in general (wireless systems operating at 10-300 GHz and above such as WiGig, IEEE 802.11ad, IEEE 802.11ay, etc.), technologies operating above 300 GHz and THz bands, (3GPP/LTE based or IEEE 802.11p or IEEE 802.11bd and other) Vehicle-to-Vehicle (V2V) and Vehicle-to-X (V2X) and Vehicle-to-Infrastructure (V21) and Infrastructure-to-Vehicle (I2V) communication technologies, 3GPP cellular V2X, DSRC (Dedicated Short Range Communications) communication systems such as Intelligent-Transport-Systems and others (typically operating in 5850 MHz to 5925 MHz or above (typically up to 5935 MHz following change proposals in CEPT Report 71)), the European ITS-G5 system (i.e. the European flavor of IEEE 802.11p based DSRC, including ITS-G5A (i.e., Operation of ITS-G5 in European ITS frequency bands dedicated to ITS for safety related applications in the frequency range 5,875 GHz to 5,905 GHz), ITS-G5B (i.e., Operation in European ITS frequency bands dedicated to ITS non-safety applications in the frequency range 5,855 GHz to 5,875 GHz), ITS-G5C (i.e., Operation of ITS applications in the frequency range 5,470 GHz to 5,725 GHz)), DSRC in Japan in the 700 MHz band (including 715 MHz to 725 MHz), IEEE 802.11bd based systems, etc.

Aspects described herein may be used in the context of any spectrum management scheme including dedicated licensed spectrum, unlicensed spectrum, license exempt spectrum, (licensed) shared spectrum (such as LSA=Licensed Shared Access in 2.3-2.4 GHz, 3.4-3.6 GHz, 3.6-3.8 GHz and further frequencies and SAS=Spectrum Access System/CBRS=Citizen Broadband Radio System in 3.55-3.7 GHz and further frequencies). Applicable spectrum bands include IMT (International Mobile Telecommunications) spectrum as well as other types of spectrum/bands, such as bands with national allocation (including 450-470 MHz, 902-928 MHz (note: allocated for example in US (FCC Part 15)), 863-868.6 MHz (note: allocated for example in European Union (ETSI EN 300 220)), 915.9-929.7 MHz (note: allocated for example in Japan), 917-923.5 MHz (note: allocated for example in South Korea), 755-779 MHz and 779-787 MHz (note: allocated for example in China), 790-960 MHz, 1710-2025 MHz, 2110-2200 MHz, 2300-2400 MHz, 2.4-2.4835 GHz (note: it is an ISM band with global availability and it is used by Wi-Fi technology family (11b/g/n/ax) and also by Bluetooth), 2500-2690 MHz, 698-790 MHz, 610-790 MHz, 3400-3600 MHz, 3400-3800 MHz, 3800-4200 MHz, 3.55-3.7 GHz (note: allocated for example in the US for Citizen Broadband Radio Service), 5.15-5.25 GHz and 5.25-5.35 GHz and 5.47-5.725 GHz and 5.725-5.85 GHz bands (note: allocated for example in the US (FCC part 15), consists four U-NII bands in total 500 MHz spectrum), 5.725-5.875 GHz (note: allocated for example in EU (ETSI EN 301 893)), 5.47-5.65 GHz (note: allocated for example in South Korea, 5925-7125 MHz and 5925-6425 MHz band (note: under consideration in US and EU, respectively. Next generation Wi-Fi system is expected to include the 6 GHz spectrum as operating band, but it is noted that, as of December 2017, Wi-Fi system is not yet allowed in this band. Regulation is expected to be finished in 2019-2020 time frame), IMT-advanced spectrum, IMT-2020 spectrum (expected to include 3600-3800 MHz, 3800-4200 MHz, 3.5 GHz bands, 700 MHz bands, bands within the 24.25-86 GHz range, etc.), spectrum made available under FCC's “Spectrum Frontier” 5G initiative (including 27.5-28.35 GHz, 29.1-29.25 GHz, 31-31.3 GHz, 37-38.6 GHz, 38.6-40 GHz, 42-42.5 GHz, 57-64 GHz, 71-76 GHz, 81-86 GHz and 92-94 GHz, etc.), the ITS (Intelligent Transport Systems) band of 5.9 GHz (typically 5.85-5.925 GHz) and 63-64 GHz, bands currently allocated to WiGig such as WiGig Band 1 (57.24-59.40 GHz), WiGig Band 2 (59.40-61.56 GHz) and WiGig Band 3 (61.56-63.72 GHz) and WiGig Band 4 (63.72-65.88 GHz), 57-64/66 GHz (note: this band has near-global designation for Multi-Gigabit Wireless Systems (MGWS)/WiGig. In US (FCC part 15) allocates total 14 GHz spectrum, while EU (ETSI EN 302 567 and ETSI EN 301 217-2 for fixed P2P) allocates total 9 GHz spectrum), the 70.2 GHz-71 GHz band, any band between 65.88 GHz and 71 GHz, bands currently allocated to automotive radar applications such as 76-81 GHz, and future bands including 94-300 GHz and above. Furthermore, the scheme may be used on a secondary basis on bands such as the TV White Space bands (typically below 790 MHz) where in particular the 400 MHz and 700 MHz bands are promising candidates. Besides cellular applications, specific applications for vertical markets may be addressed such as PMSE (Program Making and Special Events), medical, health, surgery, automotive, low-latency, drones, etc. applications.

As above, coverage is desirable for successful operation in cellular systems. Compared to LTE, NR can be deployed at relatively higher carrier frequency in frequency range 1 (FRI), e.g., at 3.5 GHz. In this case, coverage loss is expected due to the larger path-loss, which makes it more challenging to maintain an adequate quality of service. Typically, uplink coverage is one bottleneck for system operation considering the low transmit power at UE side.

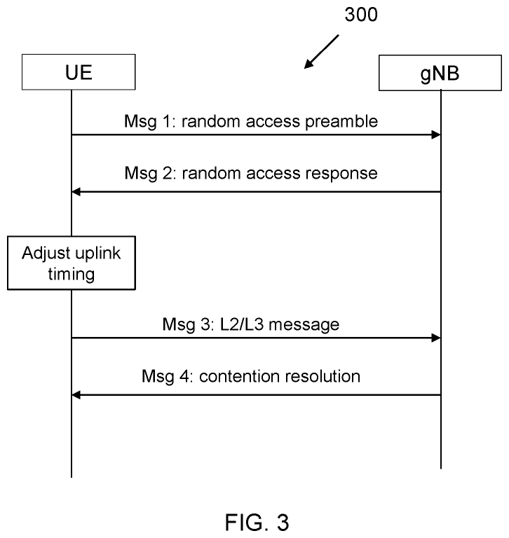

In NR Rel-15, a 4-step procedure was defined. FIG. 3 illustrates a four step RACH procedure in accordance with some embodiments. The RACH procedure 300 is for initial access. In the first operation, the UE transmits a PRACH in the uplink by randomly selecting a preamble signature, which allows the gNB to estimate the delay between the gNB and UE for a subsequent UL timing adjustment. Subsequently, in the second operation, the gNB provides as feedback a random access response (RAR) that carries timing advanced (TA) command information and an uplink grant for the uplink transmission in the third operation. The UE expects to receive the RAR within a predetermined time window, of which the start and end are configured by the gNB via a system information block (SIB).

In the first operation of the 4-step RACH procedure 300, the UE measures the reference signal received power (RSRP) from synchronization signal block (SSB) using a reception (Rx) beam and determines an SSB index with a Reference Signal Received Power (RSRP) above a configured threshold. Based on the association between the SSB and PRACH occasion, the UE selects a PRACH occasion (RO) for PRACH transmission using a transmission (Tx) beam corresponding to the selected SSB index. Note that PRACH transmission is used for a number of procedures, e.g., initial access and beam failure recovery. In order to improve the coverage for PRACH, especially for a short PRACH format, multiple PRACH transmissions with the same or different Tx beams can be employed.

When multiple PRACH transmissions use the same Tx beam during 4-step RACH procedure, certain mechanisms may be defined on the transmit power control mechanism for the PRACH transmission in order to meet a target performance for PRACH detection. Accordingly, a system and methods are described herein on transmit power control for multiple PRACH transmissions. In particular, as described herein, repetition level ramping may be used for multiple PRACH transmissions, as are transmit power control mechanisms for multiple PRACH transmissions with the same Tx beam (for each repetition) and for different Tx beams.

Repetition Level Ramping for PRACH Transmission

As indicated above, the first operation of the above 4-step RACH procedure, a UE measures the RSRP from a SSB using an Rx beam and determines an SSB index with RSRP above a configured threshold. Based on the association between the SSB and PRACH occasion, the UE selects a RO for PRACH transmission using the Tx beam corresponding to the selected SSB index. To improve the coverage for PRACH, especially for a short PRACH format, multiple PRACH transmissions with the same or different Tx beams can be employed.

When multiple PRACH transmissions using the same Tx beam are sent during 4-step RACH procedure, a mechanism may be defined on the transmit power control mechanism for PRACH transmission in order to meet a target performance for PRACH detection.

In some aspects, more than one repetition level may be configured for the multiple PRACH transmissions by higher layers via NR remaining minimum system information (RMSI), NR other system information (OSI) or dedicated radio resource control (RRC) signaling. In addition, a maximum number of attempts for multiple PRACH transmissions using a repetition level (before switching to the next repetition level) may be configured by higher layers via RMSI, OSI, or RRC signaling. In some aspects, the maximum number of attempts for multiple PRACH transmissions may be configured per repetition level. Thus, the number of repetition levels and maximum number of attempts may be provided in a PRACH configuration.

In some aspects, when the UE measures the RSRP from the SSB, the UE determines the repetition levels for the corresponding PRACH transmission in accordance with the measured RSRP and configured RSRP thresholds. If the UE does not receive an RAR, or the UE receives an RAR that does not pass contention resolution during the 4-step RACH procedure for a number of attempts (i.e., PREAMBLE_TRANSMISSION_COUNTER) that is equal to the maximum number of attempts, the UE increases the repetition level to the next configured repetition level for the next attempt for the multiple PRACH transmissions.

If the UE does not receive an RAR, or the UE receives an RAR that does not pass contention resolution during the 4-step RACH procedure for a number of attempts (i.e., PREAMBLE_TRANSMISSION_COUNTER) that is less than the maximum number of attempts, the UE continues to apply the same repetition level for the next attempt for multiple PRACH transmissions.

In one example, two repetition levels, 2 and 4 are configured for multiple PRACH transmissions and a maximum number of attempts for each repetition level is configured as 10. If a UE starts the multiple PRACH transmissions using a repetition level of 2, based on RSRP measurement, and if the UE does not receive the RAR for 10 attempts, the UE may transmit the PRACH using a repetition level of 4 for the next attempt.

In some aspects, if a UE supports both multiple PRACH transmission using the same Tx beam (mode 1) or different Tx beams (mode 2), the UE only uses one of the modes for multiple PRACH transmissions.

In addition, if the UE does not receive an RAR, or the UE receives an RAR that does not pass contention resolution during the 4-step RACH procedure for a number of attempts that is less than the maximum number of attempts, the UE applies the mode, i.e., either same Tx beam or different Tx beams for the next attempt for multiple PRACH transmissions.

Further, if the UE does not receive the RAR, or the UE receives an RAR that does not pass contention resolution during the 4-step RACH procedure for a number of attempts that is equal to the maximum number of attempts, the UE may switch to a different mode for the next attempt for multiple PRACH transmissions.

In some aspects, each repetition level for multiple PRACH transmissions is associated with more than one repetition level for a Msg3 PUSCH initial transmission and/or retransmission. In particular, more than one repetition level for a Msg3 PUSCH initial transmission and/or retransmission associated with a repetition level for multiple PRACH transmission may be configured by higher layers via RMSI, OSI, or RRC signaling.

In this case, after successful detection of multiple PRACH transmissions, the gNB determines the number of repetitions for PRACH transmission and a corresponding set of repetition levels for Msg3 initial transmission and/or retransmission. Further, the gNB may determine the number of repetitions for the Msg3 initial transmission and/or retransmission from the set of repetition levels. Then, the gNB indicates the repetition levels for the Msg3 PUSCH initial transmission and retransmission based on the existing mechanism, i.e., the most significant bit (MSB) of the modulation and coding scheme (MCS) in the RAR UL grant and a physical downlink control channel (PDCCH) with a cyclic redundancy check (CRC) scrambled by a temporary cell Radio Network Temporary Identifier (TC-RNTI) can be repurposed to indicate the repetition levels for the Msg3 PUSCH initial transmission and retransmission, respectively.

In some aspects, a UE supporting PRACH repetitions may also be expected to support repetitions for the Msg3 PUSCH.

In some aspects, for UEs that support both PRACH repetition and Msg3 PUSCH repetitions, an existing synchronization signal RSRP (SS-RSRP) threshold may be applied for triggering the PRACH and request the Msg3 PUSCH transmission.

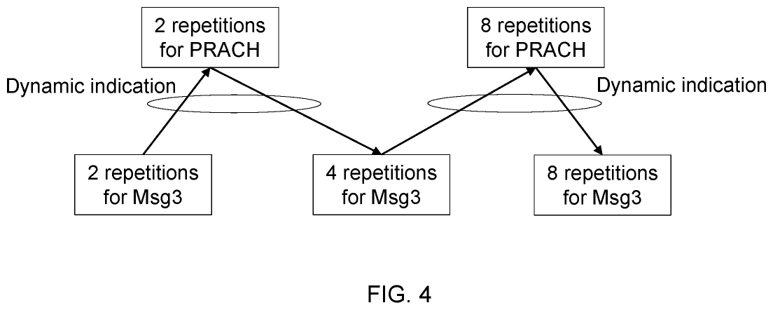

FIG. 4 illustrates association between a PRACH repetition level and Msg3 repetition level in accordance with some embodiments. In the example, two repetition levels, 2 and 8 are configured for multiple PRACH transmissions (a PRACH repetition level of 2 indicates that 2 PRACH transmissions are configured). As shown, a repetition level of 2 for multiple PRACH transmissions is associated with repetition levels of 2 and 4 for Msg3 PUSCH transmissions, and repetition level of 8 of multiple PRACH transmissions is associated with a repetition level of 4 and 8 for Msg3 PUSCH transmissions. In this case, if the UE transmits the PRACH using a repetition level of 8, the gNB may select among repetition levels 4 and 8 for Msg3 PUSCH transmission and indicate this in the MCS field in the RAR UL grant.

Transmit Power Control Mechanism for Multiple PRACH Transmissions with Same Tx Beams

In some aspects, for multiple PRACH transmissions that use the same Tx beam, if due to power allocation to PUSCH/PUCCH/PRACH/SRS transmissions as described in clause 7.5 in TS 38.213, power allocation in EN-DC, NE-DC, or NR-DC operation, slot format determination as described in clause 11.1 in TS 38.213, or the PUSCH/PUCCH/PRACH/SRS transmission occasions are in the same slot or the gap between a PRACH transmission and PUSCH/PUCCH/SRS transmission is small as described in clause 8.1 in TS 38.213, the UE does not transmit a particular PRACH in a transmission occasion within the multiple PRACH transmission occasions, UE Layer 1 notifies the higher layers to suspend the corresponding power ramping counter. Note that power ramping step size may be different across the repetition levels; the power ramping of the different repetition level is independent (and thus different power ramping counters may be used for each repetition level).

Further, for multiple PRACH transmissions that use the same Tx beam, if due to power allocation to PUSCH/PUCCH/PRACH/SRS transmissions or power allocation in EN-DC, NE-DC, or NR-DC operation, the UE transmits a PRACH with reduced power in a transmission occasion within the multiple PRACH transmission occasions, UE Layer 1 notifies the higher layers to suspend the corresponding power ramping counter.

In some aspects, for multiple PRACH transmissions that use the same Tx beam, if due to power allocation to PUSCH/PUCCH/PRACH/SRS transmissions, power allocation in EN-DC, NE-DC, or NR-DC operation, slot format determination, or the PUSCH/PUCCH/PRACH/SRS transmission occasions are in the same slot or the gap between a PRACH transmission and PUSCH/PUCCH/SRS transmission is small, the UE does not transmit any PRACH transmissions within the multiple PRACH transmission occasions, UE Layer 1 notifies the higher layers to suspend the corresponding power ramping counter.

Further, for multiple PRACH transmissions that use the same Tx beam, if due to power allocation to PUSCH/PUCCH/PRACH/SRS transmissions or power allocation in EN-DC, NE-DC, or NR-DC operation, the UE transmits all PRACH with reduced power within the multiple PRACH transmission occasions for a number of PRACH repetitions, UE Layer 1 notifies the higher layers to suspend the corresponding power ramping counter.

In some aspects, for multiple PRACH transmissions that use the same Tx beam, if due to power allocation to PUSCH/PUCCH/PRACH/SRS transmissions, power allocation in EN-DC, NE-DC, or NR-DC operation, slot format determination, or the PUSCH/PUCCH/PRACH/SRS transmission occasions are in the same slot or the gap between a PRACH transmission and PUSCH/PUCCH/SRS transmission is small, the UE does not transmit at least a number, N_{PRACH_cancelled}, of PRACH transmissions within the multiple PRACH transmission occasions, UE Layer 1 may notify he higher layers to suspend the corresponding power ramping counter. The value of N_{PRACH_cancelled} may be defined as a fraction of the total number of repetitions for a given repetition level, N_{PRACH_reps}, e.g., N_{PRACH_cancelled}=floor (m*N_{PRACH_reps}) where m may be specified or provided by higher layer signaling as part of the RACH configuration via system information (SI) messages or dedicated RRC signaling.

Further, for multiple PRACH multiple PRACH transmissions that use the same Tx beam, if due to power allocation to PUSCH/PUCCH/PRACH/SRS transmissions or power allocation in EN-DC, NE-DC, or NR-DC operation, the UE transmits at least a number, N_{PRACH_redPwr}, of PRACH transmissions with reduced power within the multiple PRACH transmission occasions, UE Layer 1 may notify the higher layers to suspend the corresponding power ramping counter. The value of N_{PRACH_redPwr} may be defined as a fraction of the total number of repetitions for a given repetition level, N_{PRACH_reps}, e.g., N_{PRACH_redPwr}=floor (n*N_{PRACH_reps}) where n may be specified or provided by higher layer signaling as part of the RACH configuration via SI messages or dedicated RRC signaling. In a further example, the same value or a common parameter may be used for m and n.

In some aspects, for multiple PRACH transmissions with a number of repetitions, the received target power for PRACH preamble in Section 5.1.3 in TS 38.321 may be updated as:

set PREAMBLE_RECEIVED_TARGET_POWER to
preambleReceivedTargetPower + DELTA_PREAMBLE +
(PREAMBLE_POWER_RAMPING_COUNTER − 1) ×
PREAMBLE_POWER_RAMPING_STEP +
POWER_OFFSET_2STEP_RA − 10*log10(repetitionLevel);

| | |
|---|---|
| - | where repetitionLevel is the number of repetitions for current |

multiple PRACH transmissions.

For this option, PREAMBLE_POWER_RAMPING_COUNTER may be reset after the repetition level ramping, i.e., when a UE switches from a first repetition level to a second repetition level for multiple PRACH transmissions. Alternatively, PREAMBLE_POWER_RAMPING_COUNTER is not reset after the repetition level ramping; instead, a common power ramping counter is maintained. Further, for this option, PREAMBLE_POWER_RAMPING_COUNTER is not incremented when the repetition level ramping counter is incremented by 1.

As a further extension, when the transmit power for multiple PRACH transmissions with the same Tx beam reaches the maximum transmit power, the power ramping counter is not incremented.

In one option, the power ramping step size may be configured separately for multiple PRACH transmissions with different repetition levels. Alternatively, a common power ramping step size may be configured for multiple PRACH transmissions with different repetition levels.

In another option, the repetition level in the equation to determine the received target power may be the number of multiple PRACH transmissions, which is configured by higher layers, regardless of whether one of the PRACH transmissions among the multiple PRACH transmissions is cancelled or dropped, e.g., due to collision with DL symbols as indicated by a dynamic slot format indication (SFI).

Alternatively, the repetition level in the equation to determine the received target power can be equal to the number of actual multiple PRACH transmissions. In this case, the number of PRACH transmissions that are cancelled or dropped are not counted to determine the received target power.

In some aspects, for multiple PRACH transmissions, when a UE switches from a first repetition level to a second repetition level, the received target power for PRACH preamble in Section 5.1.3 in TS 38.321 may be updated as:

set PREAMBLE_RECEIVED_TARGET_POWER to
preambleReceivedTargetPower + DELTA_PREAMBLE +
(PREAMBLE_POWER_RAMPING_COUNTER − 1) ×
PREAMBLE_POWER_RAMPING_STEP +
POWER_OFFSET_2STEP_RA ··
10*log10(secondRepetitionLevel/firstRepetitionLevel);

| | |
|---|---|
| - | where firstRepetitionLevel is the first number of repetitions before |

the repetition level ramping and secondRepetitionLevel is the second number
of repetition levels after the repetition level ramping.

For this option, PREAMBLE_POWER_RAMPING_COUNTER is not reset after the repetition level ramping, i.e., when a UE switches from a first repetition level to a second repetition level for multiple PRACH transmissions. That is, a common power ramping counter is maintained for the first and second repetition level for multiple PRACH transmissions. Further, for this option, PREAMBLE_POWER_RAMPING_COUNTER is not incremented when the repetition level ramping counter is incremented by 1.

As a further extension, when the transmit power for multiple PRACH transmissions with the same Tx beam reaches the maximum transmit power, the power ramping counter is not incremented.

In another option, the repetition level in the equation to determine the received target power may be the number of multiple PRACH transmissions, which is configured by higher layers, regardless of whether one of the PRACH transmissions in the multiple PRACH transmissions is cancelled or dropped.

Alternatively, the repetition level in the equation to determine the received target power may be equal to the number of actual multiple PRACH transmissions. In this case, the number of PRACH transmissions that are cancelled or dropped are not counted to determine the received target power.

In another option, for multiple PRACH transmissions that use same Tx beam, if the UE changes the spatial domain transmission filter for any of the PRACH transmissions within the multiple PRACH transmissions compared to the last multiple PRACH transmissions, UE Layer 1 notifies the higher layers to suspend the power ramping counter.

In some aspects, for multiple PRACH transmissions that use the same Tx beam, the UE first determines the pathloss in accordance with an SSB or channel state information reference signal (CSI-RS) association with the PRACH transmissions and determines the pathloss or transmit power for a first PRACH in a first PRACH occasion in accordance with the rule as defined in Clause 7.4 in TS 38.213. Further, the UE applies the determined pathloss or transmit power for the subsequent PRACH transmissions in the multiple PRACH transmissions that use the same Tx beam.

For this option, the first PRACH in the first PRACH occasion may correspond to the PRACH occasion determined for multiple PRACH transmissions, regardless of whether the first PRACH transmission in the multiple PRACH transmissions is cancelled or dropped.

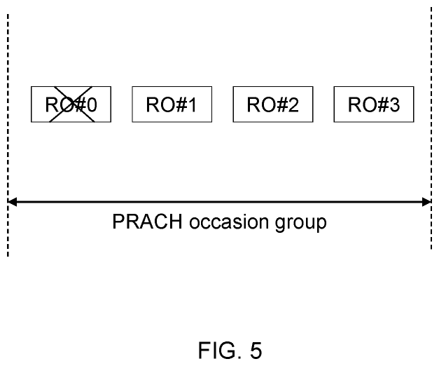

FIG. 5 illustrates transmit power for multiple PRACH transmissions that use the same Tx beam in accordance with some embodiments. As shown, one PRACH occasion group includes 4 PRACH occasions (RO). In this case, the UE first determines the transmit power for the PRACH transmission in RO #0. Even if the PRACH transmission in the RO #0 is cancelled (as shown), the UE applies the determined transmit power to the subsequent PRACH transmission in RO #1-RO #3.

In some aspects, for multiple PRACH transmission that use the same Tx beam, the UE first determines the pathloss in accordance with an SSB or CSI-RS association with the PRACH transmissions and determines the transmit power for a first actual PRACH transmission in accordance with the rule defined in Clause 7.4 in TS 38.213. Further, the UE applies the determined transmit power for the subsequent PRACH transmissions in multiple PRACH transmissions that use the same Tx beam.

In some aspects, the above embodiments can also apply for multiple PRACH transmissions with different Tx beams in which the multiple PRACH transmissions are associated with the same SSB or CSI-RS.

Transmit Power Control Mechanism for Multiple PRACH Transmissions with Different Tx Beams

In some aspects, for multiple PRACH transmissions with different Tx beams, for a PRACH transmission within the multiple PRACH transmissions, the UE determines the path loss in accordance with an SSB or CSI-RS associated with the PRACH transmission, respectively.

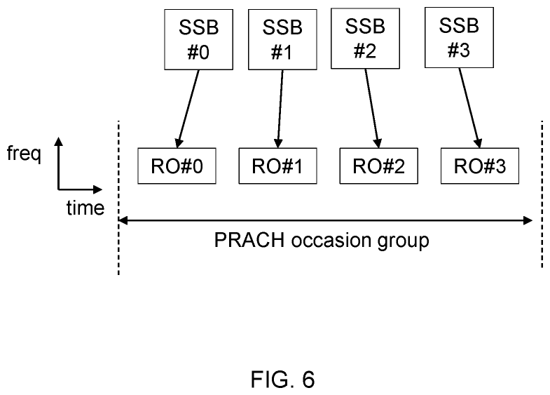

FIG. 6 illustrates path loss determination for multiple PRACH transmission with different Tx beams in accordance with some embodiments. As shown, 4 repetitions are configured for multiple PRACH transmissions with different Tx beams, where each SSB is associated with a PRACH occasion. In this case, the path loss for each PRACH transmission within the PRACH repetition window is determined based on the associated SSB.

In some aspects, for multiple PRACH transmissions with different Tx beams, the same power ramping counter is defined and maintained for all PRACH transmissions in the multiple PRACH transmissions with different Tx beams. Further, if the UE changes the spatial domain transmission filter for any of the PRACH transmission within the multiple PRACH transmissions compared to the last multiple PRACH transmissions, UE Layer 1 notifies the higher layers to suspend the power ramping counter.

In some aspects, for multiple PRACH transmissions with different Tx beams, the same power ramping counter is defined and maintained for all PRACH transmissions in the multiple PRACH transmissions with different Tx beams. Further, if the UE changes the spatial domain transmission filter for all PRACH transmissions within the multiple PRACH transmissions compared to the last multiple PRACH transmissions, UE Layer 1 may notify the higher layers to suspend the power ramping counter.

In some aspects, for multiple PRACH transmissions with different Tx beams, if the UE changes the spatial domain transmission filter for at least a number, N_{PRACH_diffTxBm}, of PRACH transmissions within the multiple PRACH transmissions compared to the last multiple PRACH transmissions, UE Layer 1 may notify the higher layers to suspend the power ramping counter. In this case, N_{PRACH_diffTxBm} may be defined as a fraction of the total number of transmissions for a given repetition level, N_{PRACH_reps}, e.g., N_{PRACH_diffTxBm}=floor (k*N_{PRACH_reps}) where k may be specified or provided by higher layer signaling as part of the RACH configuration via SI messages or dedicated RRC signaling.

In some aspects, separate power ramping counter is defined and maintained for a PRACH transmission within multiple PRACH transmissions with different Tx beams. When the UE changes the spatial domain transmission filter for a PRACH transmission within the multiple PRACH transmissions, UE Layer 1 may notify the higher layers to suspend the power ramping counter for the PRACH transmission.

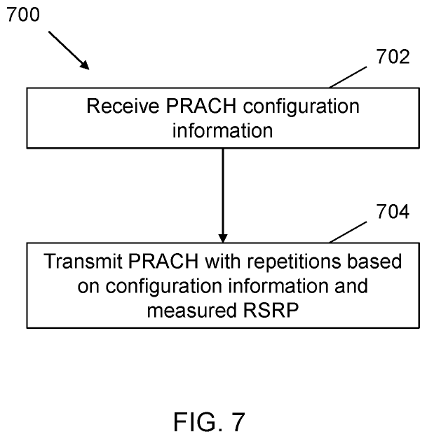

FIG. 7 illustrates a process of PRACH transmission in accordance with some embodiments. In some embodiments, the electronic device(s), network(s), system(s), chip(s) or component(s), or portions or implementations thereof, of the figures herein, may be configured to perform one or more processes, techniques, or methods as described herein, or portions thereof. One such process is depicted in FIG. 7. For example, the process may include, at operation 702, receiving configuration information. The configuration information may indicate one or more repetition levels associated with a PRACH and a maximum number of attempts that corresponds to each repetition level. At operation 704, the process may further include transmitting the PRACH with repetitions based on the configuration information and measured RSRP

### Examples

Example 1 is an apparatus of a user equipment (UE), the apparatus comprising: processing circuitry to configure the UE to: receive, from a 5th generation NodeB (gNB), a physical random access channel (PRACH) configuration, the PRACH configuration including a plurality of repetition levels for a plurality of PRACH transmissions and a maximum number of attempts for each repetition level; and transmit, to the gNB, multiple PRACH transmissions based on the PRACH configuration and measured reference signal received power (RSRP); and memory configured to store the PRACH configuration.

In Example 2, the subject matter of Example 1 includes, wherein the processing circuitry further configures the UE to: determine, for each attempt of the multiple PRACH transmissions for a current repetition level, whether at least one of a random access response (RAR) has not been received from the gNB or has not passed contention resolution; and in response to a determination that the at least one of the RAR has not been received from the gNB or has not passed contention resolution and that the maximum number of attempts has been reached for the current repetition level, increase the current repetition level to a next configured repetition level for a next attempt of the multiple PRACH transmissions.

In Example 3, the subject matter of Example 2 includes, wherein, in response to a determination that the at least one of the RAR has not been received from the gNB or has not passed contention resolution and that the maximum number of attempts has not been reached for the current repetition level, the processing circuitry further configures the UE to maintain the current repetition level for the next attempt of multiple PRACH transmissions.

In Example 4, the subject matter of Examples 1-3 includes, wherein the processing circuitry further configures the UE to configure the maximum number of attempts using higher layers via at least one of remaining minimum system information (RMSI), other system information (OSI), or Radio Resource Control (RRC) signaling.

In Example 5, the subject matter of Examples 1-4 includes,) physical uplink shared channel (PUSCH) initial transmission or retransmission.

In Example 6, the subject matter of Examples 1-5 includes, wherein the processing circuitry further configures the UE to: use an identical transmission (Tx) beam or spatial domain filter or each of the multiple PRACH transmissions; determine whether a power allocation condition has been met; and in response to a determination that the power allocation condition has been met, cancel a single PRACH transmission in a transmission occasion within a plurality of PRACH transmission occasions and provide notification from UE Layer 1 to higher layers to suspend a corresponding power ramping counter.

In Example 7, the subject matter of Examples 1-6 includes, wherein the processing circuitry further configures the UE to: use an identical transmission (Tx) beam or spatial domain filter for each of the PRACH transmissions; determine whether a power allocation condition has been met; and in response to a determination that the power allocation condition has been met, reduce power of a single PRACH transmission in a transmission occasion within a plurality of PRACH transmission occasions and provide notification from UE Layer 1 to higher layers to suspend a corresponding power ramping counter.

In Example 8, the subject matter of Examples 1-7 includes, wherein the processing circuitry further configures the UE to: use an identical transmission (Tx) beam or spatial domain filter for each of the PRACH transmissions; determine whether a power allocation condition has been met; and in response to a determination that the power allocation condition has been met, cancel all PRACH transmissions within a plurality of PRACH transmission occasions and provide notification from UE Layer 1 to higher layers to suspend a corresponding power ramping counter.

In Example 9, the subject matter of Examples 1-8 includes, wherein the processing circuitry further configures the UE to: use an identical transmission (Tx) beam or spatial domain filter for each of the multiple PRACH transmissions; determine whether a power allocation condition has been met; and in response to a determination that the power allocation condition has been met, reduce power of all PRACH transmissions within a plurality of PRACH transmission occasions for a predetermined number of PRACH repetitions and provide notification from UE Layer 1 to higher layers to suspend a corresponding power ramping counter.

In Example 10, the subject matter of Examples 1-9 includes, wherein the processing circuitry further configures the UE to determine a received target power of a PRACH preamble at the gNB for each PRACH transmission as: PREAMBLE_RECEIVED_TARGET_POWER to preambleReceivedTargetPower+DELTA_PREAMBLE+(PREAMBLE_POWER_RAMPING_COUNTER−1)×PREAMBLE_POWER_RAMPING_STEP+POWER_OFFSET_2STEP_RA−10*log 10(repetitionLevel), where repetitionLevel is a number of repetitions determined for the multiple PRACH transmissions.

In Example 11, the subject matter of Examples 1-10 includes, wherein the processing circuitry further configures the UE to: switch from a first repetition level for the multiple PRACH transmissions to a second repetition level for the multiple PRACH transmissions; and in response to the switch, determine a received target power for a PRACH preamble at the gNB for each PRACH transmission as: PREAMBLE_RECEIVED_TARGET_POWER to preambleReceivedTargetPower+DELTA_PREAMBLE+(PREAMBLE_POWER_RAMPING_COUNTER−1)×PREAMBLE_POWER_RAMPING_STEP+POWER_OFFSET_2STEP_RA−10*log 10(secondRepetitionLevel/firstRepetitionLevel), where firstrepetitionLevel is a number of repetitions for the multiple PRACH transmissions before repetition level ramping using the first repetition level and secondrepetitionLevel is a number of repetitions for the multiple PRACH transmissions after the repetition level ramping using the second repetition level.

In Example 12, the subject matter of Examples 1-11 includes, wherein at least one of: the processing circuitry further configures the UE to maintain a single power ramping counter for all PRACH transmissions in the multiple PRACH transmissions, or the maximum number of attempts is independent for each repetition level.

In Example 13, the subject matter of Examples 1-12 includes, wherein the processing circuitry further configures the UE to: use an identical transmission (Tx) beam or spatial domain filter for each of the multiple PRACH transmissions; determine whether a transmit power for the multiple PRACH transmissions has reached a maximum transmit power; and cancel incrementation of a power ramping counter in response to a determination that the transmit power for the multiple PRACH transmissions has reached the maximum transmit power.

In Example 14, the subject matter of Examples 1-13 includes, wherein the processing circuitry further configures the UE to: use an identical transmission (Tx) beam or spatial domain filter for each of the multiple PRACH transmissions; determine, for each PRACH transmission within the multiple PRACH transmissions, a pathloss in accordance with at least one of a synchronization signal block (SSB) or channel state information reference signal (CSI-RS) associated with the multiple PRACH transmissions; and after a determination of the pathloss, determine a transmit power for a first PRACH in the multiple PRACH transmissions and apply the determined pathloss or transmit power for subsequent PRACH transmissions in the multiple PRACH transmissions.

In Example 15, the subject matter of Examples 1-14 includes, wherein the processing circuitry further configures the UE to: use an identical transmission (Tx) beam or spatial domain filter for each of the multiple PRACH transmissions; determine, for each PRACH transmission within the multiple PRACH transmissions, a pathloss in accordance with at least one of a synchronization signal block (SSB) or channel state information reference signal (CSI-RS) associated with the multiple PRACH transmissions; and after a determination of the pathloss, determine a pathloss or transmit power for a first actual PRACH transmission and apply the determined transmit power for subsequent PRACH transmissions in the multiple PRACH transmissions.

In Example 16, the subject matter of Examples 1-15 includes, wherein the processing circuitry further configures the UE to: measure RSRP of a synchronization signal block (SSB) or channel state information reference signal (CSI-RS); and determine which of the repetition levels to use for the PRACH transmissions dependent on the measured RSRP of the SSB or CSI-RS and configured RSRP thresholds.

Example 17 is an apparatus of a 5th generation NodeB (gNB), the apparatus comprising: processing circuitry to configure the gNB to: transmit, to a user equipment (UE), a physical random access channel (PRACH) configuration that includes, repetition levels for a plurality of PRACH transmissions and a maximum number of attempts for each repetition level, the maximum number of attempts being at least one of identical or independent for each repetition level; receive, from the UE, multiple PRACH transmissions based on the PRACH configuration; and transmit a random access response (RAR) in response to reception of each PRACH transmission and measured reference signal received power (RSRP); and memory configured to store the PRACH configuration.

In Example 18, the subject matter of Example 17 includes, wherein the processing circuitry further configures the gNB to configure the maximum number of attempts using higher layers via at least one of remaining minimum system information (RMSI), other system information (OSI), or Radio Resource Control (RRC) signaling.

Example 19 is a non-transitory computer-readable storage medium that stores instructions for execution by one or more processors of a user equipment (UE), the one or more processors to configure the UE to, when the instructions are executed: receive, from a 5th generation NodeB (gNB), a physical random access channel (PRACH) configuration, the PRACH configuration including repetition levels for a plurality of PRACH transmissions and a maximum number of attempts for each repetition level, the maximum number of attempts being at least one of identical or independent for each repetition level; and transmit, to the UE, multiple PRACH transmissions based on the PRACH configuration and measured reference signal received power (RSRP).

In Example 20, the subject matter of Example 19 includes, wherein the one or more processors, when the instructions are executed, configure the UE to: determine, for each attempt of the multiple PRACH transmissions for a current repetition level, whether at least one of a random access response (RAR) has not been received from the gNB or has not passed contention resolution; in response to a determination that the at least one of the RAR has not been received from the gNB or has not passed contention resolution and that the maximum number of attempts has been reached for the current repetition level, increase the current repetition level to a next configured repetition level for a next attempt of the multiple PRACH transmissions; and in response to a determination that the at least one of the RAR has not been received from the gNB or has not passed contention resolution and that the maximum number of attempts has not been reached for the current repetition level, maintain the current repetition level for the next attempt of the multiple PRACH transmissions.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Although an embodiment has been described with reference to specific example embodiments, it will be evident that various modifications and changes may be made to these embodiments without departing from the broader scope of the present disclosure. Accordingly, the specification and drawings are to be regarded in an illustrative rather than a restrictive sense. The accompanying drawings that form a part hereof show, by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

The subject matter may be referred to herein, individually and/or collectively, by the term “embodiment” merely for convenience and without intending to voluntarily limit the scope of this application to any single inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

In this document, the terms “a” or “an” are used, as is common in patent documents, to indicate one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, UE, article, composition, formulation, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects. As indicated herein, although the term “a” is used herein, one or more of the associated elements may be used in different embodiments. For example, the term “a processor” configured to carry out specific operations includes both a single processor configured to carry out all of the operations as well as multiple processors individually configured to carry out some or all of the operations (which may overlap) such that the combination of processors carry out all of the operations. Further, the term “includes” may be considered to be interpreted as “includes at least” the elements that follow.

The Abstract of the Disclosure is submitted with the understanding that it will not be used to interpret or limit the scope or meaning of the claims. In addition, in the foregoing Detailed Description, it may be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus of a user equipment (UE), the apparatus comprising:
processing circuitry to configure the UE to:
receive, from a 5^{th} generation NodeB (gNB), a physical random access channel (PRACH) configuration, the PRACH configuration including a plurality of repetition levels for a plurality of PRACH transmissions and a maximum number of attempts for each repetition level; and
transmit, to the gNB, multiple PRACH transmissions based on the PRACH configuration and measured reference signal received power (RSRP); and
memory configured to store the PRACH configuration.

2. The apparatus of claim 1, wherein the processing circuitry further configures the UE to:
determine, for each attempt of the multiple PRACH transmissions for a current repetition level, whether at least one of a random access response (RAR) has not been received from the gNB or has not passed contention resolution; and
in response to a determination that the at least one of the RAR has not been received from the gNB or has not passed contention resolution and that the maximum number of attempts has been reached for the current repetition level, increase the current repetition level to a next configured repetition level for a next attempt of the multiple PRACH transmissions.

3. The apparatus of claim 2, wherein, in response to a determination that the at least one of the RAR has not been received from the gNB or has not passed contention resolution and that the maximum number of attempts has not been reached for the current repetition level, the processing circuitry further configures the UE to maintain the current repetition level for the next attempt of multiple PRACH transmissions.

4. The apparatus of claim 1, wherein the processing circuitry further configures the UE to configure the maximum number of attempts using higher layers via at least one of remaining minimum system information (RMSI), other system information (OSI), or Radio Resource Control (RRC) signaling.

5. The apparatus of claim 1, wherein the processing circuitry further configures the UE to associate each of the repetition levels with at least one repetition level for at least one of a message 3 (Msg3) physical uplink shared channel (PUSCH) initial transmission or retransmission.

6. The apparatus of claim 1, wherein the processing circuitry further configures the UE to:
use an identical transmission (Tx) beam or spatial domain filter or each of the multiple PRACH transmissions;
determine whether a power allocation condition has been met; and
in response to a determination that the power allocation condition has been met, cancel a single PRACH transmission in a transmission occasion within a plurality of PRACH transmission occasions and provide notification from UE Layer 1 to higher layers to suspend a corresponding power ramping counter.

7. The apparatus of claim 1, wherein the processing circuitry further configures the UE to:
use an identical transmission (Tx) beam or spatial domain filter for each of the PRACH transmissions;
determine whether a power allocation condition has been met; and
in response to a determination that the power allocation condition has been met, reduce power of a single PRACH transmission in a transmission occasion within a plurality of PRACH transmission occasions and provide notification from UE Layer 1 to higher layers to suspend a corresponding power ramping counter.

8. The apparatus of claim 1, wherein the processing circuitry further configures the UE to:
use an identical transmission (Tx) beam or spatial domain filter for each of the PRACH transmissions;
determine whether a power allocation condition has been met; and
in response to a determination that the power allocation condition has been met, cancel all PRACH transmissions within a plurality of PRACH transmission occasions and provide notification from UE Layer 1 to higher layers to suspend a corresponding power ramping counter.

9. The apparatus of claim 1, wherein the processing circuitry further configures the UE to:
use an identical transmission (Tx) beam or spatial domain filter for each of the multiple PRACH transmissions;
determine whether a power allocation condition has been met; and
in response to a determination that the power allocation condition has been met, reduce power of all PRACH transmissions within a plurality of PRACH transmission occasions for a predetermined number of PRACH repetitions and provide notification from UE Layer 1 to higher layers to suspend a corresponding power ramping counter.

10. The apparatus of claim 1, wherein the processing circuitry further configures the UE to determine a received target power of a PRACH preamble at the gNB for each PRACH transmission as:
PREAMBLE_RECEIVED_TARGET_POWER to preambleReceivedTargetPower+DELTA_PREAMBLE+(PREAMBLE_POWER_RAMPING_COUNTER−1)×PREAMBLE_POWER_RAMPING_STEP+POWER_OFFSET_2STEP_RA−10*log 10(repetitionLevel),
where repetitionLevel is a number of repetitions determined for the multiple PRACH transmissions.

11. The apparatus of claim 1, wherein the processing circuitry further configures the UE to:
switch from a first repetition level for the multiple PRACH transmissions to a second repetition level for the multiple PRACH transmissions; and
in response to the switch, determine a received target power for a PRACH preamble at the gNB for each PRACH transmission as:
PREAMBLE_RECEIVED_TARGET_POWER to preambleReceivedTargetPower+DELTA_PREAMBLE+(PREAMBLE_POWER_RAMPING_COUNTER−1)×PREAMBLE_POWER_RAMPING_STEP+POWER_OFFSET_2STEP_RA−10*log 10(secondRepetitionLevel/firstRepetitionLevel),
where firstrepetitionLevel is a number of repetitions for the multiple PRACH transmissions before repetition level ramping using the first repetition level and secondrepetitionLevel is a number of repetitions for the multiple PRACH transmissions after the repetition level ramping using the second repetition level.

12. The apparatus of claim 1, wherein at least one of the processing circuitry further configures the UE to maintain a single power ramping counter for all PRACH transmissions in the multiple PRACH transmissions, or
the maximum number of attempts is independent for each repetition level.

13. The apparatus of claim 1, wherein the processing circuitry further configures the UE to:
use an identical transmission (Tx) beam or spatial domain filter for each of the multiple PRACH transmissions;
determine whether a transmit power for the multiple PRACH transmissions has reached a maximum transmit power; and
cancel incrementation of a power ramping counter in response to a determination that the transmit power for the multiple PRACH transmissions has reached the maximum transmit power.

14. The apparatus of claim 1, wherein the processing circuitry further configures the UE to:
use an identical transmission (Tx) beam or spatial domain filter for each of the multiple PRACH transmissions;
determine, for each PRACH transmission within the multiple PRACH transmissions, a pathloss in accordance with at least one of a synchronization signal block (SSB) or channel state information reference signal (CSI-RS) associated with the multiple PRACH transmissions; and
after a determination of the pathloss, determine a transmit power for a first PRACH in the multiple PRACH transmissions and apply the determined pathloss or transmit power for subsequent PRACH transmissions in the multiple PRACH transmissions.

15. The apparatus of claim 1, wherein the processing circuitry further configures the UE to:
use an identical transmission (Tx) beam or spatial domain filter for each of the multiple PRACH transmissions;
determine, for each PRACH transmission within the multiple PRACH transmissions, a pathloss in accordance with at least one of a synchronization signal block (SSB) or channel state information reference signal (CSI-RS) associated with the multiple PRACH transmissions; and
after a determination of the pathloss, determine a pathloss or transmit power for a first actual PRACH transmission and apply the determined transmit power for subsequent PRACH transmissions in the multiple PRACH transmissions.

16. The apparatus of claim 1, wherein the processing circuitry further configures the UE to:
measure RSRP of a synchronization signal block (SSB) or channel state information reference signal (CSI-RS); and
determine which of the repetition levels to use for the PRACH transmissions dependent on the measured RSRP of the SSB or CSI-RS and configured RSRP thresholds.

17. An apparatus of a 5^{th} generation NodeB (gNB), the apparatus comprising:
processing circuitry to configure the gNB to:
transmit, to a user equipment (UE), a physical random access channel (PRACH) configuration that includes repetition levels for a plurality of PRACH transmissions and a maximum number of attempts for each repetition level, the maximum number of attempts being at least one of identical or independent for each repetition level;
receive, from the UE, multiple PRACH transmissions based on the PRACH configuration; and
transmit a random access response (RAR) in response to reception of each PRACH transmission and measured reference signal received power (RSRP); and
memory configured to store the PRACH configuration.

18. The apparatus of claim 17, wherein the processing circuitry further configures the gNB to configure the maximum number of attempts using higher layers via at least one of remaining minimum system information (RMSI), other system information (OSI), or Radio Resource Control (RRC) signaling.

19. A non-transitory computer-readable storage medium that stores instructions for execution by one or more processors of a user equipment (UE), the one or more processors to configure the UE to, when the instructions are executed:
receive, from a 5^{th} generation NodeB (gNB), a physical random access channel (PRACH) configuration, the PRACH configuration including repetition levels for a plurality of PRACH transmissions and a maximum number of attempts for each repetition level, the maximum number of attempts being at least one of identical or independent for each repetition level; and
transmit, to the UE, multiple PRACH transmissions based on the PRACH configuration and measured reference signal received power (RSRP).

20. The medium of claim 19, wherein the one or more processors, when the instructions are executed, configure the UE to:
determine, for each attempt of the multiple PRACH transmissions for a current repetition level, whether at least one of a random access response (RAR) has not been received from the gNB or has not passed contention resolution;
in response to a determination that the at least one of the RAR has not been received from the gNB or has not passed contention resolution and that the maximum number of attempts has been reached for the current repetition level, increase the current repetition level to a next configured repetition level for a next attempt of the multiple PRACH transmissions; and
in response to a determination that the at least one of the RAR has not been received from the gNB or has not passed contention resolution and that the maximum number of attempts has not been reached for the current repetition level, maintain the current repetition level for the next attempt of the multiple PRACH transmissions.
